(19) United States
(12) Patent Application Publication
(10) Pub. No.: US 2023/0053704 A1
(43) Pub. Date: Feb. 23, 2023

(54) TRAFFIC AND INTERSECTION MONITORING SYSTEM

(71) Applicant: DenseFogg Technology, LLC, Rochester, NY (US)

(72) Inventors: Joseph M. Denny, Fairport, NY (US); Gregory P. Fogarty, Fairport, NY (US); Muhammad M. Naseer, Lahore (PK)

(73) Assignee: DenseFogg Technology, LLC, Rochester, NY (US)

(21) Appl. No.: 17/885,614

(22) Filed: Aug. 11, 2022

Related U.S. Application Data
(60) Provisional application No. 63/234,041, filed on Aug. 17, 2021.

(51) Int. Cl. G08G 1/097; G08G 1/095; G08G 1/015; G08G 1/056

(52) U.S. Cl. CPC G08G 1/097; G08G 1/015; G08G 1/056; G08G 1/095

(57) ABSTRACT

A traffic intersection monitoring system and method to ensure a traffic signal is viewable by vehicles, bicyclists, and pedestrians, by measuring the color light intensity of the signal light, and monitoring the orientation of the traffic signal light. Each phase of color is timed and coordinated with traffic counters to generate a real-time status of predicted future traffic signal light color with corresponding traffic volume. The predicted status and traffic counts are published for the use of any applicable subscriber of the traffic intersection monitoring system.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever. 37 C.F.R 1.71(d).

### CROSS REFERENCE TO RELATED APPLICATIONS

This application claims priority from Provisional Application No. 63/234,041, filed on Aug. 17, 2021, in the U.S. Pat. and Trademark Office, the disclosure of which is incorporated herein in its entirety by reference.

### BACKGROUND OF THE INVENTIVE CONCEPT

### 1. Field of the Invention

The present invention relates generally to detecting traffic signal light viewability from the perspective of the motorist, pedestrian, or unmanned vehicle and counting vehicle traffic in relation to traffic signal light color detection and signal light phase change. More specifically, the field of view, orientation, and luminosity of signal light is measured to ensure viewability by approaching vehicles. The elapsed time of each illuminated color phase is measured and synchronized with traffic volume counts, independent of the existing signal light controller infrastructure. The traffic signal light functional status, the predicted timing of signal light phase change, and the traffic volume count data are communicated to applicable subscribers to perform real-time traffic congestion management, and to predict future traffic light status and traffic flow along the network of traffic signal lights and planned driving routes.

### 2. Description of the Related Art

Traffic signals are used worldwide to govern the flow of vehicular traffic. To safely control a vehicle, it is necessary for the driver of a vehicle to first locate the nearest signal light governing the direction of travel, then to view, interpret, and react to the color of the signal light. The safety of all motorists approaching an intersection of roadways is completely reliant on each driver successfully locating the signal light and correctly interpreting and reacting to its color status.

Unmanned vehicles require equivalent signal light information as manned vehicles to operate safely in an environment mixed with both manned and unmanned vehicles. Like manned vehicles, unmanned vehicles must develop an understanding of where the signal lights are located and what is the color phase of the light, then to appropriately react to the signal light.

Efforts have been made to provide on-board detection of the signal light phase and timing status within the vehicle including vision-based approaches to locate, detect, and interpret the signal color. This information is communicated internally to an engine controller of a vehicle, and the vehicle responds accordingly to the observed light information.

Other efforts have been made to communicate the signal light phase and timing status through Vehicle-to-Infrastructure (V2I) data communication technologies. An interface device can be installed to the traffic signal controller to detect the active signal light being controlled by sensing voltage or current on control wires of the traffic signal controller.

Another common method to determine signal light phase and timing status is for a device connected to the local controller to receive a data packet directly from the local controller. The data packet can be processed to determine the controlled state of the signal light, and the signal light status can be communicated to vehicles via a V2I-compatible data radio. The vehicle receives the data packet, and the information is communicated internally to the engine controller of the vehicle, and the vehicle responds accordingly to the communicated light information.

Similar approaches require the data packets communicated by some traffic controllers to central Traffic Management Systems (TMS) be duplicated and routed to signal light phase and timing status prediction databases. The estimated signal phase timing data is time-shifted to compensate for the potential communication delays in such an approach. The predicted signal light phase and timing status is then communicated from the remote database to the infrastructure, and a V2I radio communicates the data to the equipped vehicles.

Each of these general approaches have limitations in practice. In the case of vision-based applications, the approaching vehicle must be aware of exactly where to “look” for the signal light upon approach to the light. Next it must correctly interpret the color of the light. If the light is out, or the light is obscured, the vehicle must deploy a safety measure to compensate for the lack of signal light clarity. There is no room for a vision-based system to misinterpret the location or the color of a light, if a signal light is misinterpreted the consequences can be catastrophic.

There are also edge cases that must be solved including the installation of temporary traffic lights or newly installed traffic lights. The on-board, vision-based system must be aware of the location of every light governing its approach. These edge case conditions require real-time update of the on-board database to correctly locate the signals. Weather related edge cases also present challenges to vision-based systems, with heavy snow and fog potentially obscuring the signal light.

The vision-based approach may not allow for the vehicle to understand the phase light timing of each upcoming signal in a desired driving route, therefore diminishing a desirable feature of traffic signal light phase and timing status prediction, the ability to moderate vehicle speed to ensure less stopping, less idling, and less greenhouse emissions.

Infrastructure-related technologies also present limitations. The infrastructure-based approaches require physical connection to the local signal light controller, or to sense data packets generated by the signal light controller that are communicated to a TMS. These approaches only infer the color light is viewable, and in some cases an incorrect and potentially unsafe signal light status will be communicated to V2I-equipped vehicles. There are documented cases where the light is controlled to be energized, yet it is not viewable due to causes not detected by the signal controller. One example is heavy snow packed against each color aspect of the signal light. Another example is a blinding windstorm completely obscuring the signal lights.

Another limitation to the infrastructure-based approach is the installed base of signal light controllers range from legacy controllers operating on a standalone basis to modern, microprocessor-based signal light controllers capable of communicating status to a TMS. The mixed range of technologies deployed today may require standardization and costly upgrades to serve the needs of communities to reduce traffic congestion and to adopt the future requirements of unmanned and autonomous vehicles.

### SUMMARY OF THE INVENTIVE CONCEPT

The present invention relates generally to detecting traffic signal light viewability from the perspective of the motorist, pedestrian, or manned/unmanned vehicle and counting vehicle traffic in relation to traffic signal light color detection and signal light phase change. More specifically, the field of view, orientation, and luminosity of signal light is measured to ensure viewability by approaching vehicles. The elapsed time of each illuminated color phase is measured and synchronized with traffic volume counts, independent of the existing signal light controller infrastructure. The traffic signal light functional status, the predicted timing of signal light phase change, and the traffic volume count data are communicated to applicable subscribers to perform real-time traffic congestion management, and to predict future traffic light status and traffic flow along with the network of traffic signal lights and planned driving routes.

One aspect of the invention provides a device to detect the color light output of an illuminated traffic signal light by direct measurement of the analog luminance value. The device used to detect the illuminated signal light may be mounted near the signal light lens structure and will be external to the signal light to account for the loss of light transmissibility through obstructive materials that may be obscuring the signal light lens. The device will measure and report on any reduction in light transmissibility to prevent a remote observer from incorrectly identifying the signal light color status.

In another example, the color light output of the traffic signal light is detected by a device positioned within the color light, with a second detector focused on a reflecting surface located outside the signal light lens structure.

In another example, the color light output of the traffic signal light is detected by a device positioned from a remote and fixed location in view of each aspect of the signal light.

Another aspect of the invention is the device used to detect the illuminated signal light may be connected to one or more identical devices and placed at each instance of a traffic signal light aspect. In this way, a series of detectors may be positioned along the front face of a traffic signal light with each detector corresponding to a distinct signal light. The series of detectors provide a complete assessment of the illumination and elapsed time of illumination for each color phase on a traffic signal.

Another aspect of the invention provides a device to measure the installed orientation of the signal light to ensure the signal light orientation is correctly aligned with the correct lane segmentation of oncoming vehicular traffic. One example of measuring the installed orientation of the light is to collaborate it with a 9-axis inertial measurement unit (IMU).

Another example of measuring the installed orientation of the light is to collaborate it with an image or several images captured by a corresponding camera and compare all images to a reference image representing the correct orientation of the signal light.

Another example of measuring the installed orientation of the light is to collaborate it with a ranging sensor to compare all measured distances to a reference distance representing the correct orientation of the signal light. Another aspect of the invention provides for a traffic counter to detect realtime traffic conditions and traffic volume count synchronized with signal light status. The information can provide predicted signal light phase and timing status synchronized with traffic flow estimates to aid in the vehicle and pedestrian routing. The information derived from these measurements will also be used to model future traffic control scenarios for traffic engineering studies.

One example of a traffic counter is to utilize the camera sensor used to determine the correct orientation of the installed traffic signal light. The camera will be equipped with an image recognition processor and perform the task of segmenting traffic lanes, counting vehicular, bicycle, and pedestrian traffic.

Another example of a traffic counter is to utilize range measuring sensors to detect the presence of a passing vehicle. Range measuring sensors will provide a constant distance value when no traffic is present. When traffic is detected by the range measuring sensor, the distance sensor will return the point distance detected across the profile of a moving vehicle. The point distance may be used to determine vehicle types, such as car, truck, or bus.

Another example of a traffic counter is to utilize the existing infrastructure including traffic loops, radar detectors, magnetometers, or camera systems. The data generated by any of these existing sensors can be merged with the data generated by the traffic signal light color phase detector to produce an asynchronous relationship between the color phase and vehicular traffic.

Another aspect of the invention provides for the detection of preemptive inputs originated by pedestrians, bicyclists, emergency vehicles, and railroad train traffic. The detected preemptive inputs will alter the signal light’s color phase and the timing of the phase. By detecting these random signal light preemption inputs, the accuracy of signal light color phase, phase timing, and traffic buildup conditions will be kept current to actual multimode traffic conditions.

Another aspect of the invention provides a Device Communication Controller (DCC) or device communication controllers physically wired to the infrastructure to provide a power source and connected by wire or wirelessly to each Traffic Signal Light Monitor (T-SLM) and each Traffic Volume Counter Device (T-VCD). Each device communication controller will monitor the traffic light signal color phase and the time for each phase. Each device communication controller will monitor traffic signal light orientation. The device communication controller will also connect by wire or wirelessly to all traffic volume counter modules and may also process captured images for the purpose of determining traffic count. The device communication controller will synchronize the detected traffic count with the traffic signal light phase and timing on a per lane basis, including right and left-turn lanes.

Another aspect of the invention is to accumulate all measured parameters into a table held in the device communication controller’s internal memory. The top-most row of the table contains the current and time-stamped measured condition of a single traffic intersection, the subsequent and following rows of the table contain time-stamped entries from earlier measurements.

Another aspect of the invention includes a GNSS receiver located within the device communication controller to provide a uniform and stable time base for all device communication controllers installed in a geographical area.

The GNSS receiver provides a common time base with the unique latitude and longitude coordinates of the installed device communication controller. The fixed location of the GPS receiver will generate measurements representing a locus of data points centered around the unique latitude and longitude coordinates of the device.

Another aspect of the invention is to monitor the GNSS received data and compare it to previously captured GNSS received data and measure any changes to the data sets. The received GNSS data is also shared with other nodes within a geographical area to detect any changes to the GNSS data. Such changes may relate to degraded GNSS dynamic performance and may affect the routing logic on car-borne navigation systems.

Another aspect of the invention is to publish relevant and current information regarding the status of the local traffic signal light health, the received GNSS signal health, and the estimated signal phasing and timing pattern for the next phase cycle. The synchronized vehicle traffic counts are also published based on the direction of travel of the detected traffic.

Another aspect of the invention is to capture the relevant traffic signal light phasing and timing physically independent from the legacy traffic control system.

Another aspect of the invention is to create a network of adjacent, signal-controlled intersections by equipping each intersection with Traffic Signal Light Monitors, Traffic Volume Counter Devices, and Device Communication Controllers. Adjacent nodes will communicate their current, time-stamped, predicted traffic signal light phase timing and traffic volume counts to each neighboring subscriber.

Another aspect of the invention is to share the predicted signal phase timing and the volume of expected traffic to all subscribers including adjacent intersection nodes, vehicles, bicyclists, and pedestrians within the network.

Another aspect of the invention is to share the predicted signal phase timing and the volume of expected traffic to subscribers based on a route request communicated by a mobile subscriber including vehicles, bicyclists, and pedestrians within the network.

Another aspect of the invention is to combine the predicted signal phase timing and the volume of expected traffic from adjacent nodes with the information into a single, route-dependent message and communicated to a mobile subscriber based on the subscriber’s route request.

As an example, assume a vehicle is approaching an intersection and the vehicle subscribes to receive status data from the intersection’s Device Communication Controller. Depending on whether the vehicle intends to turn left, turn right, or drive straight through the intersection, the message the vehicle receives from the intersection’s Device Communication Controller will include the predicted phase change timing derived by the intersection plus the predicted phase change timing and traffic volume count of the next intersection along the intended route.

Another aspect of the invention is for a specific intersection location to subscribe to a cloud-based server to receive the current updated status of all adjacent intersections.

Another aspect of the invention is to publish to a cloud-based server the status information for a specific intersection location. The published status could include the status of the specific intersection and the status of all adjacent intersections directly approachable in an individual vehicle’s route.

Another aspect of the invention is to communicate to adjacent intersections through the cloud or direct point to multi-point radio communications. Connecting intersection Device Communication Controllers through data radio reduces the number of cloud-based connections.

Another aspect of the invention is to process subscriber route requests to augment traffic volume prediction at adjacent intersections. As an example, if ten vehicles request status data for the signalized intersection before executing a left turn, the system will process these requests and understand the ten vehicles will be approaching within a calculated timeframe.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 is a system diagram providing an overview of multiple Intersections equipped with Traffic and Intersection Monitoring Systems (TIMS) wherein each TIMS comprises of Traffic Signal Light Monitor (T-SLM), Traffic Volume Counter Device (TVCD), and Device Communication Controller (DCC) communicating to multiple information recipients.

FIG. 2 is a diagram showing a single intersection equipped with a Traffic and Intersection Monitoring System (TIMS) and the communication paths for various components of the system.

FIG. 3 is a diagram showing a traffic signal equipped with Traffic Signal Light Monitor (T-SLM), and Traffic Volume Counter Device (T-VCD) communicating to Device Communication Controller (DCC) and the communication interfaces to information recients.

FIG. 4 is a block diagram showing various components of a Traffic Signal Light Monitor (T-SLM).

FIG. 5 is a block diagram showing various components of a Traffic Volume Counter Device (T-VCD).

FIG. 6 is a block diagram showing various components of a Device Communication Controller (DCC).

FIG. 7 is a block diagram showing various components of TIMS modules and their communication interfaces.

FIG. 8 is a diagram showing a two-way traffic intersection equipped with TIMS and illustrates the logic for the traffic volume computation.

The drawings illustrate a few example embodiments of the present inventive concept, and therefore are not to be considered limiting in its scope, as the overall inventive concept may admit to other equally effective embodiments. The elements and features shown in the drawings are to scale and attempt to clearly illustrate the principles of exemplary embodiments of the present inventive concept. In the drawings, reference numerals designate like or corresponding, but not necessarily identical, elements throughout the several views.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept are omitted.

It will be understood that although the terms “first” and “second” may be used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to an intention of one of ordinary skill in the art, case precedents, or the appearance of new technologies. Also, some terms may be arbitrarily selected by the applicant, and in this case, the meaning of the selected terms will be described in detail in the detailed description of the invention. Thus, the terms used herein have to be defined based on the meaning of the terms together with the description throughout the specification.

Also, when a part “includes” or “comprises” an element, unless there is a particular description contrary thereto, the part can further include other elements, not excluding the other elements. In the following description, terms such as “unit” and “module” indicate a unit to process at least one function or operation, wherein the unit and the module may be embodied as hardware or software or embodied by combining hardware and software.

Hereinafter, one or more exemplary embodiments of the present general inventive concept will be described in detail with reference to accompanying drawings.

Example embodiments of the present general inventive concept are directed to a Traffic and Intersection Monitoring System (TIMS). An example Traffic and Intersection Monitoring System (TIMS) includes a Traffic Signal Light Monitor (T-SLM), a Traffic Volume Counter Device (T-VCD), a Device Communication Controller (DCC), a Cloud-based Application Server (CBAS), and a Subscriber Application (SA).

The Traffic Intersection Monitoring System (TIMS) may be installed at any single, signalized traffic intersection, and may be completely independent of the existing, legacy traffic controller. There may be one Traffic Signal Light Monitor (T-SLM) to monitor each distinct signal head, independent of the number of light-indications on the signal head. The signal head may house the multiple color light indications (for instance, Green, Yellow, Red, plus any turn indications) used to govern traffic movement. For instance, an intersection may include a single, four-sided signal head to govern the movement of traffic at an intersection. Each side of the signal light may face the oncoming traffic. A single T-SLM may monitor the light output from all four sides of the signal head and for each light in the signal head, independent of the direction of traffic the light is designed to provide its color indication. In another embodiment, a T-SLM may be installed in proximity to each signal head at an intersection including more than one signal head. Therefore, more than one T-SLM may be installed at each signalized intersection.

The T-SLM may include multiple diverse and redundant sensors to detect the illuminated light’s color and intensity values. The T-SLM may also include multiple, diverse and redundant sensors to detect a change in the orientation of the signal head. The T-SLM may provide local timing of each color and its time on phase. The T-SLM may also assemble a data message including the color phase, the time on phase, the indicating direction of the color phase, and the change in orientation of the signal head.

A Traffic Volume Counter Device (T-VCD) may be installed above the lane of travel such that vehicles will be detected and counted as they pass under the T-VCD as the vehicle drives through an intersection. The number of T-VCD’s at an intersection may be based on the number of lanes. The T-VCD may include multiple diverse and redundant sensors to detect passing vehicles and to classify the vehicle type. Possible vehicle classifications include motorcycle, automobile, van, pickup truck, delivery truck, semi-trailer truck, and bus, among other classification possibilities.

The T-SLM’s and the T-VCD’s may be powered through a wired connection to a Device Communication Controller (DCC). The DCC may be powered by the municipal power source used to power the signal lights. In a typical embodiment, there may be a single DCC per traffic intersection, though the architecture of the system allows for multiple DCC’s at a single traffic intersection. The T-SLM’s and the T-VCD’s may communicate data by wire or wirelessly to the DCC. Wireless communication may occur on a dedicated, shortrange local area network. The LAN may be constructed with WiFi, BLUETOOTH®, ANT, or any other secure wireless communication architecture. The DCC may include a processor and storage memory sufficient to process the data communicated by multiple T-SLM’s and T-VCD’s. The DCC may collect the measured color phase times from each T-SLM and calculate an algorithm to predict the next cycle of phase colors and associated time on phase. These predicted phase timings may be correlated to the detected lane by lane traffic counts and may be populated in a data message format suitable for publishing said data to a Cloud-based Application Server (CBAS).

The Device Communication Controller (DCC) may also include a Global Positioning Satellite (GNSS) receiver. The GNSS receiver may provide a common date and time indication for all DCC’s located in a geographical region such as a traffic grid. The common date and time indication provide synchronization to all monitors and controllers in a TIMS network. Since the DCC is installed at a fixed location, it is possible to survey the fixed location and calculate highly accurate latitude and longitude coordinates of the DCC location. These fixed coordinates may be retained in the DCC memory as the Ground Truth location. Received GNSS satellite signals and the calculated inference location from these signals may be compared over time with the Ground Truth location. It is established that GNSS readings vary over time, and the DCC may use an algorithm to measure the variance to the Ground Truth and publish this real-time variance to the Cloud-based Application Server (CBAS). The variance information may be subscribed to by vehicles utilizing GNSS navigation systems to either correct for on-board location errors or to alert when a GNSS signal error creates unsafe routing information to the vehicle, particularly with autonomous vehicles which are completely reliant on the accuracy of GNSS guidance data.

There are multiple Subscriber Applications (SA) based on the subscriber classification. One subscriber classification may be the fixed, signalized traffic intersection location equipped with a TIMS system. This arrangement allows adjacent TIMS-equipped intersection locations to communicate and publish their real-time status to a cloud-based computer and database. Each subscribing TIMS-equipped intersection location may receive timely status conditions for all neighboring TIMS-equipped intersection locations. The status conditions for neighboring TIMS-equipped intersection locations may be concatenated with the local TIMS-equipped intersection location.

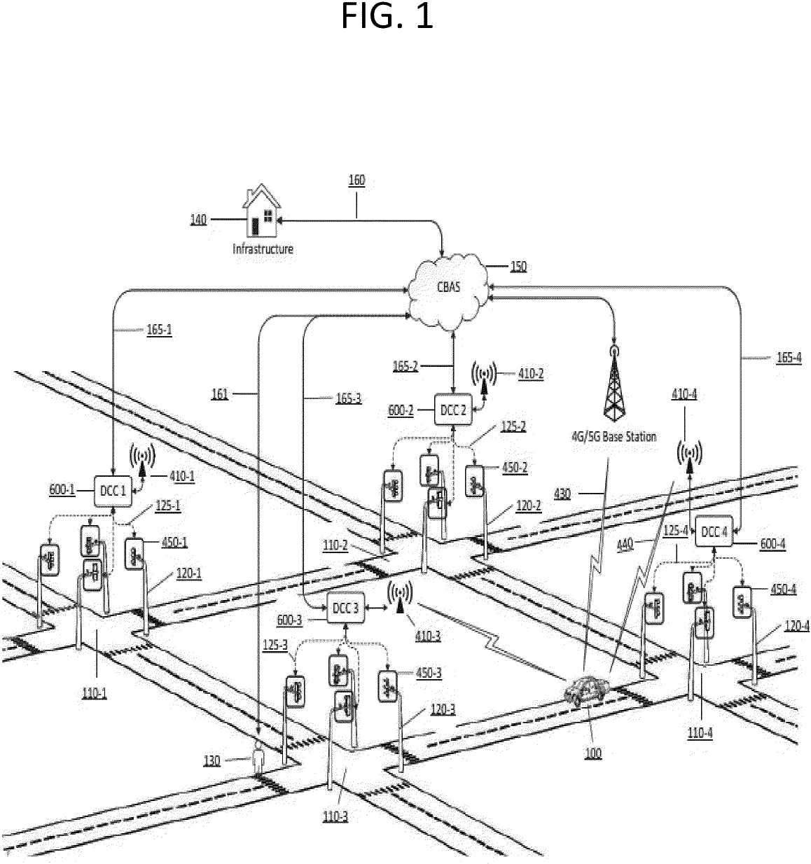

FIG. 1 presents a system having four traffic intersections 110-1, 110-2, 1103, and 110-4 equipped with a traffic intersection monitoring system according to one embodiment of the present invention. The TIMS comprises a network of multiple sensors blocks 450-1, 450-2, 450-3, and 450-4 in communication with the Device Communication Controller DCC 600-1, 600-2, 600-3, and 600-4 respectively. The DCC 600-1, 600-2, 600-3, and 600-4 are wirelessly connected directly through the Radio Interfaces 410-1, 410-2, 410-3 and 410-4 respectively and also through the CBAS 160 through interfaces 165-1, 165-2, 1653 and 165-4 respectively; and provide actionable information to the vehicle 100, the pedestrian 130, the infrastructure 140 and other applicable subscribers.

The traffic intersections 110-1, 110-2, 110-3, and 110-4 may be equipped with multiple sensors blocks 450-1, 450-2, 450-3, and 450-4 respectively which may be installed on the existing signal light posts 120-1, 120-2, 120-3, and 120-4 in this example embodiment. The sensor blocks 450-1, 450-2, 450-3, and 450-4 communicate with DCC 6001, 600-2, 600-3, and 600-4 respectively, through wireless communication interfaces 125-1, 125-2, 125-3 and 125-4 and/or by using wired interfaces. In the example embodiment, the wireless communication takes place in the 900 MHz ISM band, however, other communication bands and techniques may also be used. The data generated from the diverse sensor blocks 450-1, 450-2, 450-3, and 450-4 includes raw values of, three-axis accelerometer, a three-axis magnetometer, and a three-axis gyroscope from nine-axis Inertial Measurement Unit (IMU) for orientation determination, signal light intensity and color information from a light sensor for signal health, image from vision sensor for traffic signal light viewability and orientation, a video feed from the camera module, and vehicle distance, size and direction from LIDAR and/or RADAR for vehicle count and type determination, GNSS health and coordinate information for GNSS signal outage and location correction, and other data related to signal light integrity or useful for applicable subscribers. The DCC 600-1 processes the sampled sensor data from the local sensor block 450-1 and the information reported from the neighboring DCCs 600-2, 600-3, and 600-4 and provides actionable information to the applicable subscribers, including pedestrian 130, vehicle 100, and infrastructure 140. The applicable subscribers having a V2X (vehicle to everything) interface 440, and in the communication range of the DCC 600-4 may receive the subscribed information from the DCC 600-4 directly. For the other subscribers not in the direct communication range of any of the DCC 600-1, 600-2, 6003, and 600-4 or without having a V2X interface, the information published to the CBAS 150 may be retrieved by the pedestrian 130, vehicle 100 and infrastructure 140 through any compatible network interface; some of the example interfaces may include 4G/5G cellular network interface 430, 4G/5G cellular network interface or Wi-Fi 161 and 4G/5G cellular network interface or Wi-Fi or Ethernet 160.

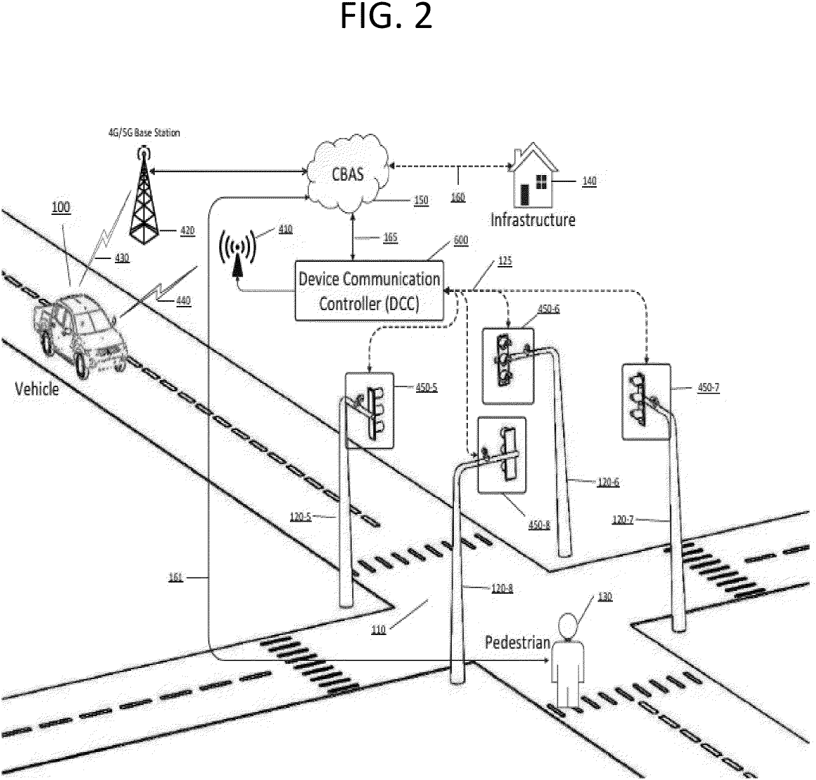

FIG. 2 shows a traffic intersection 110 having four (4) signal light posts 120-5, 120-6, 120-7, and 120-8 including or hosting sensor blocks 450-5, 450-6, 450-7, and 450-8 respectively monitoring the health and orientation of signal light and counting the vehicles passing through the traffic intersection 110. Sensors installed on the signal light posts 120-5, 120-6, 120-7, and 120-8 may communicate with the Device Communication Controller DCC 600 through the wireless communication interface 125 and/or wired interfaces. Each of the sensors blocks 450-5, 450-6, 450-7, and 450-8 can directly communicate with DCC 600 over a wireless star network. However, other alternative network formations which will perform the intended operations of the inventive concept as described herein, such as, for example a wireless mesh network, may also be used. In this example embodiment, the wireless communication takes place in the 900 MHz ISM band. However, other alterative communication bands and techniques may also be used, which will perform the intended operations of the inventive concept as described herein. In addition to the data received from local sensor blocks 450-5, 450-6, 450-7, and 450-8, the DCC 600 may receive information from the neighboring DCCs and/or provide actionable information to the applicable subscribers, such as the pedestrian 130, the vehicle 100, the infrastructure 140 and the traffic intersection operator. The DCC 600 may publish information to the CBAS 150 and also directly communicate it to the applicable subscribers wirelessly. The DCC 600 updates actionable information to the CBAS 150 through the network interface 165, which may be any wired or wireless internet connection. For direct communication between the DCC 600 and applicable subscribers, Cellular V2X (C-V2X) may be used either in direct communication mode using PC5 interface 440 of the 3GPP (3rd generation partnership project), through any other direct device-to-device communication interface, or through the existing cellular interface 430 by the cellular network 420. The DCC 600 may use the radio 410 for direct communication with the applicable subscribers as well as for communicating with the neighboring DCCs. In another embodiment, a wired interface may also be used for direct communication between the neighboring DCCs. The infrastructure subscriber may receive the actionable information from the crossing intersection through any wired or wireless internet connection 160.

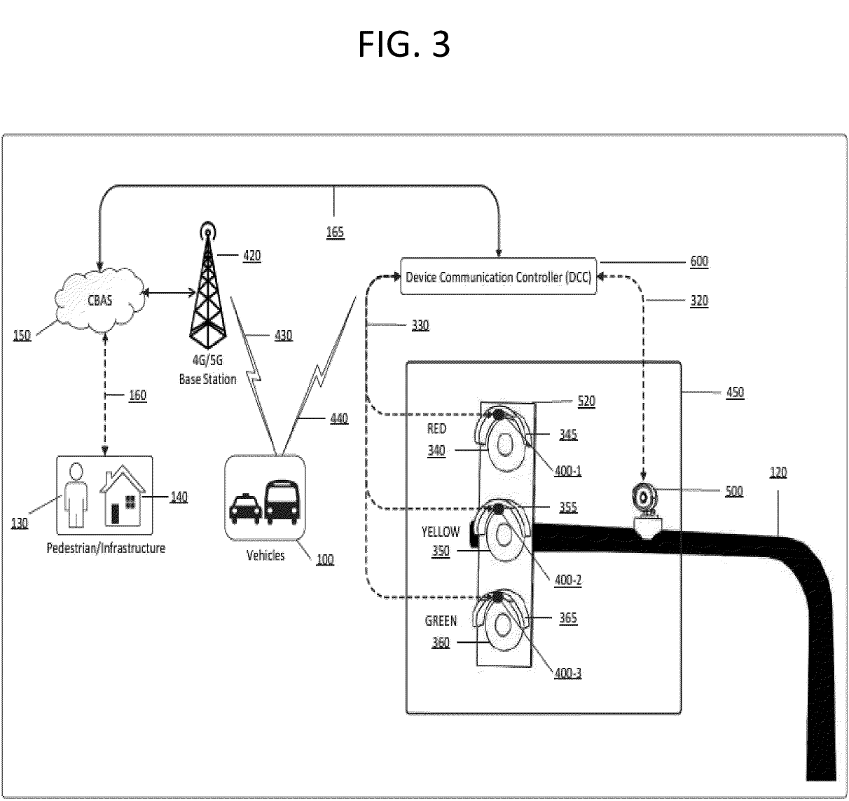

FIG. 3 shows a signal light post 120 including or hosting red 340, yellow 350, and green 360 traffic signal lights. Each signal light post 120 may include or be instrumented with a set of traffic signal lights 520 which serves traffic coming from a particular direction. The signal light post 120 may be equipped with a sensor block 450 including multiple sensors such as traffic signal light monitors (T-SLMs) 400-1, 400-2, and 400-3 and a traffic volume counter device (T-VCD) 500.

Each of the T-SLM 400-1, 400-2, and 400-3 monitors signal light intensity, color, ON/OFF duration, orientation, and viewability from the perspective of a pedestrian 130 and vehicle 100 for the traffic signal lights red 340, yellow 350 and green 360, respectively. The T-SLM 400-1, 400-2, and 400-3 may be attached to the bottom surface of the sun visor 345, 355, and 365, respectively, in such a way that it is directly in the path of light emitting from the signal lights 340, 350 and 360. The traffic volume counter device T-VCD 500, attached to the signal light post 120, may perform various functions such as vehicle detection, vehicle profiling, and counting the vehicular traffic.

The T-VCD 500 may utilize a combination of diverse sensors including a camera module, LIDAR, and RADAR. In this example embodiment, one T-VCD monitors traffic on one lane only. However, in another embodiment, one T-VCD may monitor traffic on one or more than one lane. Each of the traffic signal light monitors T-SLM 400-1, 400-2, and 400-3 may communicate directly with the DCC 600 through a wired or wireless communication interface 330. The TVCD 500 may also communicate directly with the DCC 600 through a wired or wireless communication interface 320. The DCC 600 processes the received information from the local sensors and the neighboring DCCs to determine actionable information for applicable subscribers. The DCC 600 may upload the actionable information to a CBAS 150 through any wired or wireless internet connection 165. The DCC 600 may directly communicate actionable information to the vehicles 100 over a C-V2X interface, the cellular network 430, or directly through PC5 or any other direct device-to-device communication interface 440. The applicable subscribers, such as vehicle 100, pedestrian 130, and infrastructure 140 may also receive actionable information from the CBAS 150 through any wired or wireless internet connection 160.

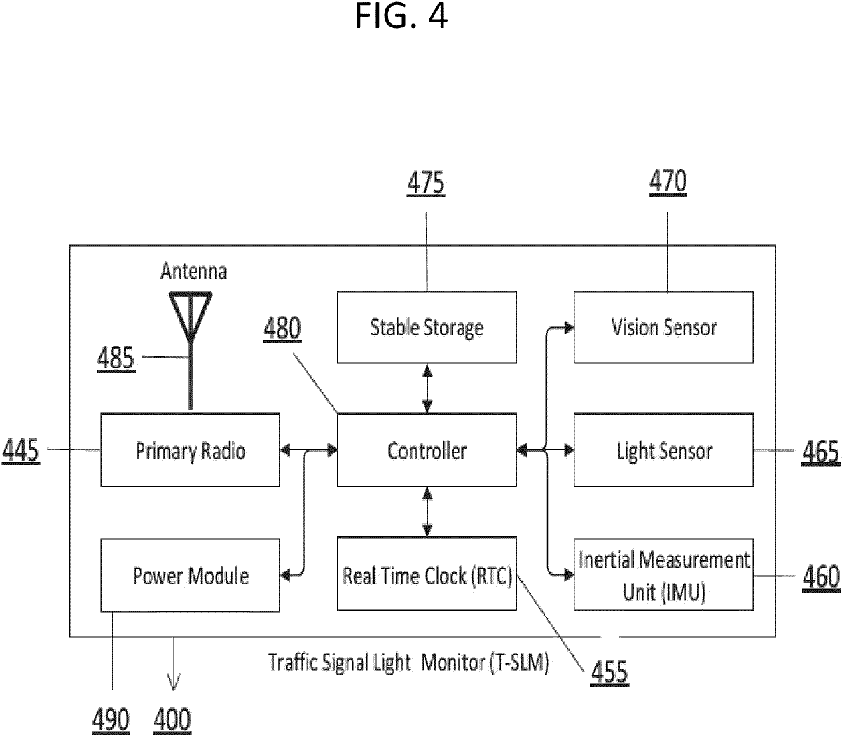

FIG. 4 is a block diagram showing an example embodiment of various modules of the traffic signal light monitor T-SLM 400. A controller 480 may execute the traffic signal light monitor software to perform functions such as startup verifications, processing parameters received from various sensors, and preparation of data packets to be transmitted to the device communication controller. The T-SLM 400 may include a wireless communication module 445 for communicating with the device communication controller. An example of the wireless communication module 445 may be a primary radio 445. The primary radio 445 may be a BLUETOOTH® classic or low energy module, XBEE, Wi-Fi, or any other wireless communication module, and may use an external antenna 485 to extend the range of wireless communication. A power module 490 can be included to provide power for various components of the T-SLM 400. The power module 490 can be any type of module which will provide sufficient power to the various components of the T-SLM 400. The configuration parameters for different modules and system diagnostic events may be stored on a persistent storage module 475. A real-time clock RTC 455 may also be included in the T-SLM 400 for timekeeping purposes, such as time-stamping of sensor data and diagnostic events. The T-SLM 400 may use a vision sensor 470 to determine that the signal light view is unobstructed and no change in orientation of signal light has occurred over time. A light sensor 465 may provide information to the controller 480 for monitoring signal light intensity, color, and ON/OFF duration. An IMU 460 may be used to monitor the orientation of the signal light.

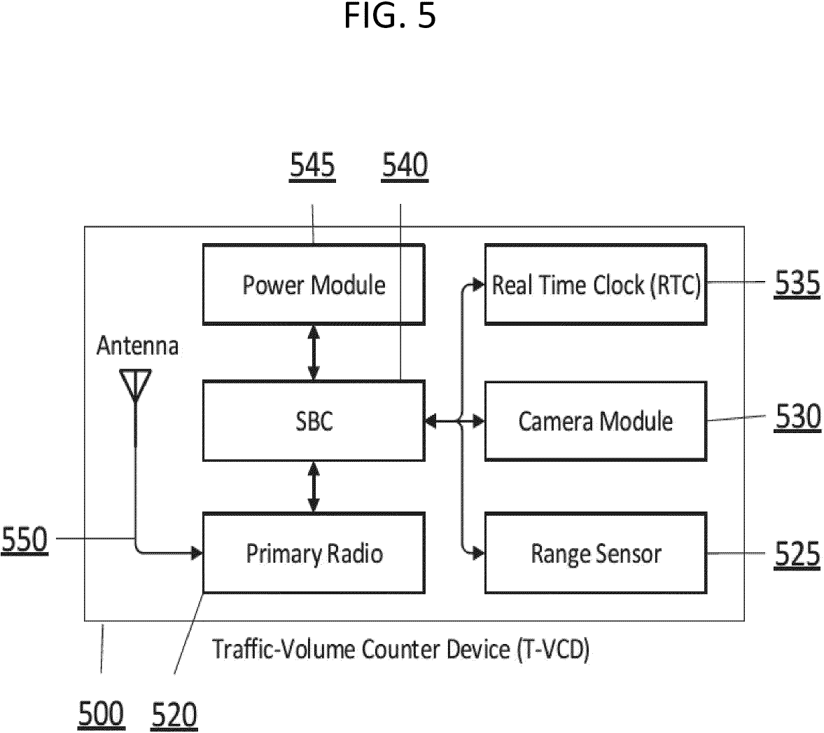

FIG. 5 is a block diagram showing an example embodiment of various modules on the traffic volume counter device T-VCD 500. A single-board computer SBC 540 may be provided to execute the traffic volume counter device software to perform functions such as startup verifications, processing parameters received from various sensors, implementing vehicle counting logic, and preparation of data packets to be transmitted to the device communication controller. An SBC 540 may be any single or multi-core processor attached to a memory that may be volatile, persistent, or a combination thereof and capable of executing the software for the TVCD 500. A power module 545 can be provided, which includes circuitry to provide power to various modules of the T-VCD 500. A primary radio 520 on the T-VCD 500 enables wireless communications with the device communication controller. The primary radio 520 may be a BLUETOOTH® classic or low energy module, XBEE, Wi-Fi, or any other wireless communication module, and may use an external antenna 550 to extend the range of wireless communication. A realtime clock RTC 535 may also be available on the T-VCD 500 for timekeeping purposes, which may comprise time-stamping of sensor data and diagnostic events. The T-VCD 500 may comprise a camera module 530 positioned such that all the incoming and outgoing vehicular traffic of the crossing intersection is in the view of the camera module 530. The video feed from the camera module 530 may be used to determine the type and count of the incoming vehicular traffic. The T-VCD 500 may also include a range sensor 525 which may be a LIDAR or RADAR or any other sensor to detect vehicle distance, size, profile, count, and direction.

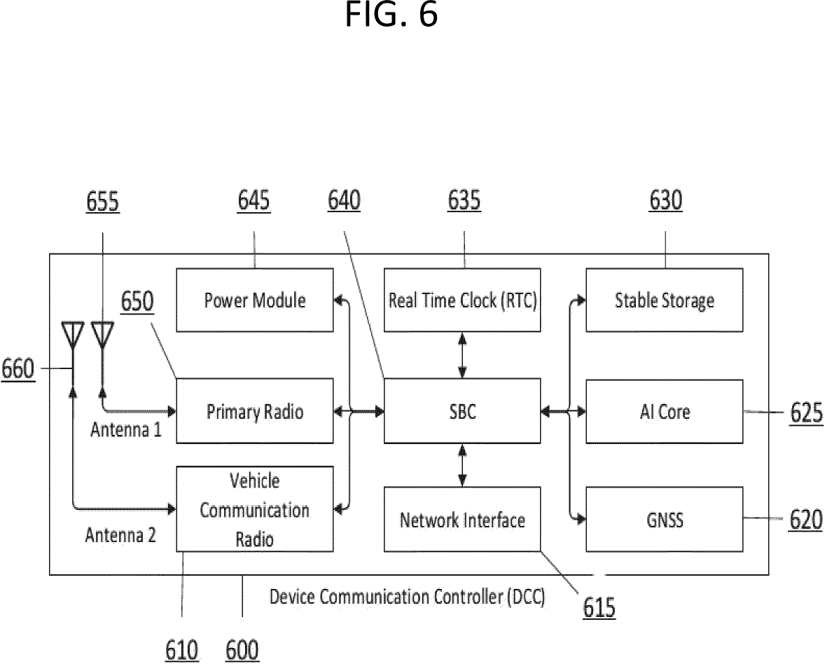

FIG. 6 is a block diagram showing an example embodiment of various modules on the DCC 600. A single-board computer (SBC) 640 may execute the device communication controller software to perform functions such as startup verifications, processing of the sensors data received from the traffic signal light monitor and traffic volume counter device and preparation of data packets to be transmitted to the neighboring device communication controllers, vehicles, and CBAS. The SBC 640 may also receive data from the modules present on the DCC 600 (such as GNSS) and offload computations to the Artificial Intelligence (AI) core 625. SBC 540 may be any single or multi-core processor attached to a memory that may be volatile, persistent, or a combination thereof and capable of executing the software for DCC 600. A power module 645 may provide power to various components on the DCC 600. A primary radio 650 may be used for communication with the traffic signal light monitor and traffic volume counter device. The primary radio 650 may use an external antenna 655 to extend the range of wireless communication.

Still referring to FIG. 6, the DCC 600 may also include a secondary radio (vehicle communication radio) 610 for direct communication between the DCC 600 to neighboring DCCs and between the DCC 600 to vehicles. The vehicle communication radio 610 may use an external antenna 660 to extend the range of wireless communication. A real-time clock (RTC) 635 may also be available on the DCC 600 for all timekeeping purposes. The DCC 600 may communicate with the CBAS through a network interface 615 such as Wi-Fi, Ethernet, 4G/5G cellular networks, or any other interface that provides network connectivity. The DCC 600 may also use an auxiliary stable storage 630 to keep back-ups of the useful information, such as sensor data received from traffic signal light monitor, traffic volume counter device, and system diagnostic information. The DCC 600 may also include a dedicated Artificial Intelligence (AI) core 625 to offload AI-related processing from the SBC 640. The dedicated AI core 625 may be used for data analytics on sensor data using AI-based algorithms, such as convolutional neural networks (CNN), temporal convolutional networks (TCN), and long short-term memory (LSTM) networks. The dedicated AI core 625 may include or be hosted with a pre-trained AI model, an online learning algorithm may be deployed to adopt the temporal changes at the traffic intersections or a combination thereof. These AI algorithms may perform various functions such as vehicle counting by using video stream from the camera module and signal light orientation determination using image data from the vision sensor. A Global Navigation Satellite System (GNSS) 620 module on the DCC 600 may provide GNSS 620 signal health in the area, the number of satellites visible, current location, and precise time to the DCC 600.

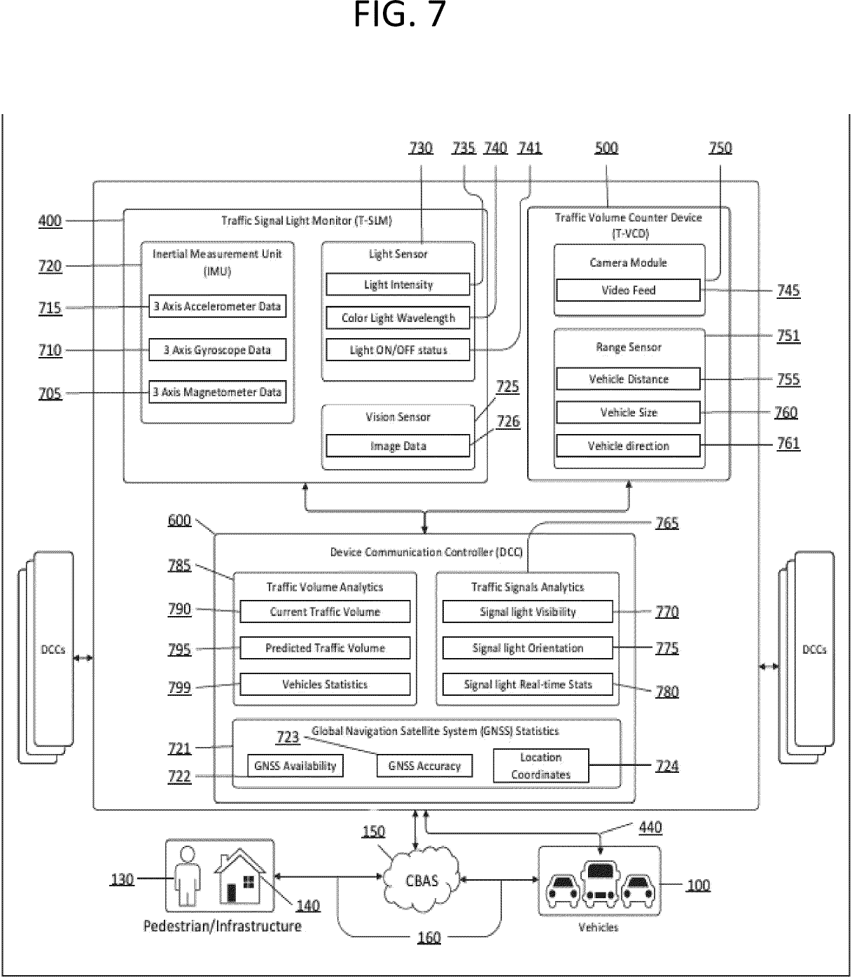

FIG. 7 shows data 715, 710, 705, 735, 740, 741, 726, 745, 755, 760, and 761 generated by various sensors available on T-SLM 400 and T-VCD 500. This figure also shows publishable information 790, 795, 799, 770, 775, and 780 generated at the DCC 600 by taking into account the sensors data 715, 710, 705, 735, 740, 741, 726, 745, 755, 760, and 761 from the T-SLM 400 and T-VCD 500 and published information by the neighboring DCCs.

The T-SLM 400 comprises various sensors including an inertial measurement unit (IMU) 720, a light sensor 730, and a vision sensor 725. T-SLM 400 may monitor the orientation of the signal light from the perspective of a pedestrian 130 and vehicle 100 and for this purpose, it may use a nine (9) axis IMU 720. The nine (9) axis output from the IMU 720 includes three (3) axis gravitational acceleration from an accelerometer 715, three (3) axis angular velocity from a gyroscope 710, and three (3) axis magnetic field measurement from a magnetometer 705. T-SLM 400 processes the nine (9) axis output from the IMU 720 and computes the precise orientation of the signal light on which T-SLM 400 is installed. The reference orientation of signal light is stored, both locally on the T-SLM 400 and the DCC 600, as a reference to determine any change in the orientation of the traffic signal light.

The T-SLM 400 may include the light sensor 730 to sense multiple color lights and clear light intensity during different lighting conditions. The light sensor 730 provides a digital light intensity 735, color light wavelength 740, and light ON/OFF status 741 for a particular colored signal light on which it is installed. This information is used to determine whether the signal light intensity is within a normal sensing range. In an example embodiment of this disclosure, the value of signal light intensity measured in lumens by light sensor 730 is compared to a predetermined threshold of luminous intensity in candela for an LED signal module (e.g., as specified by Transport Canada Engineering Standards for LED Signal Modules or the American Railway Engineering and Maintenance of Way Association (AREMA) standard for LED signal modules). In this example embodiment, predetermined thresholds for signal light viewability, integrity, and conspicuity may be stored as a reference on the T-SLM 400 and DCC 600. One or more predetermined thresholds may be converted to lumens before comparing with the values measured by the light sensor 730. For example, the measured light intensity values for each color signal light may be compared to the minimum luminous intensity values for the three different colored lights as pre-configured on the TSLM 400.

A vision sensor 725 available on the T-SLM 400 is simultaneously oriented on the signal light monitor with other sensors. The vision sensor 725 is oriented such that it has a full view of the road in front of the signal light on which the T-SLM 400 is installed. Image data 726 captured by vision sensor 725 may be used to determine whether the signal light view is unobstructed and that no change in orientation of signal light has occurred.

In some example embodiments, the T-SLM 400 may provide partial or fully processed sensors data such as precise signal light orientation calculated from the IMU 720, or it may be configured to offload all the computations to the DCC 600 and provide only raw sensors data 715, 710, 705, 735, 740, 741, 85, 755, 760 and 761 to the DCC.

The Traffic Volume Counter Device (T-VCD) 500 comprises multiple sensors, such as a camera module 750 and a range sensor 751, which may be a LIDAR and/or RADAR or any other sensor to detect vehicle distance 755, vehicle size 760, and vehicle direction 761. Camera module 750 is positioned such that incoming and outgoing vehicular traffic of the crossing intersection is in the view of the camera module 750. A video feed 745 from the camera module 750 may be used to determine the type and count of incoming vehicular traffic towards the traffic crossing intersection. The camera module 750 may also be used to determine the direction of the vehicles, such as left-turn, right-turn, U-turn, or straight movement. Furthermore, for accuracy and redundancy, the range sensor 751 may provide additional information such as vehicle distance 755, vehicle size 760, and vehicle direction 761. T-VCD 500 may be configured to provide processed sensors data such as a count of the vehicular traffic at the traffic intersection or it may be configured to offload partial or all the computation to the DCC 600 and provide only raw sensors data 745, 755, 760, and 761 to the DCC 600.

The DCC 600 may receive time-stamped information from the T-SLM 400 which comprises raw or (partially) processed three (3) axis accelerometer data 715, three (3) axis gyroscope data 710, three (3) axis magnetometer data 705, light intensity 735, color light wavelength 740, light ON/OFF status 741 and image data 726. DCC 600 may also receive video feed 745, vehicle distance 755, vehicle size 760, and vehicle direction 761 from the TVCD 500. The DCC 600 may implement data analytics on the information it receives from multiple sensors and may produce traffic signal analytics 765 and traffic volume analytics 785. Traffic signal analytics 765 may be based on the information received from the local TSLM 400 which comprises signal light visibility 770 status, signal light orientation 775, and signal real-time light ON/OFF status 741 for every individual signal light. The traffic volume analytics 785 may be based on the information received from the T-VCD 500 in addition to the information received from multiple DCCs installed nearby. Traffic volume analytics 785 comprises current traffic volume 790 and predicted traffic volume 795 calculated based on the input from the T-VCD 500 in addition to traffic volume count and expected time of arrival reported by the neighboring DCCs. Traffic volume analytics 785 may also involve vehicle statistics 799 which may include the count of the different types of vehicles passing through the traffic intersection.

In some embodiments, the pre-installed external sensors at the traffic intersections, having a compatible communication interface with the DCC 600, may also be used for data analytics. For example, loop sensors are widely used for vehicle counting and presence detection may provide information to the DCC 600 to augment current traffic volume 790 and vehicle direction 761.

The DCC 600 may compute Global Navigation Satellite System (GNSS) statistics 721 from the information received from an onboard GNSS module. The DCC 600 may publish GNSS availability 722, GNSS accuracy 723, and GNSS location coordinates 724 directly to the vehicle 100 or the CBAS 150 for applicable subscribers. The applicable subscribers, such as self-driving cars, may utilize this information and may take appropriate driving actions such as avoiding the intersections where the GNSS accuracy may be compromised.

The DCC 600 may publish traffic signal analytics 765, traffic volume analytics 785, and GNSS statistics 721 directly to the vehicles through a vehicle communication interface 440. The vehicle communication interface 440 may be a C-V2X or any other supported interface by the vehicle 100. Traffic signal analytics 765, traffic volume analytics 785, and GNSS statistics 721 may also be made available to any applicable subscribers, such as pedestrians 130, infrastructure 140, and vehicles 100 through CBAS 150 using any wired or wireless internet connection 160.

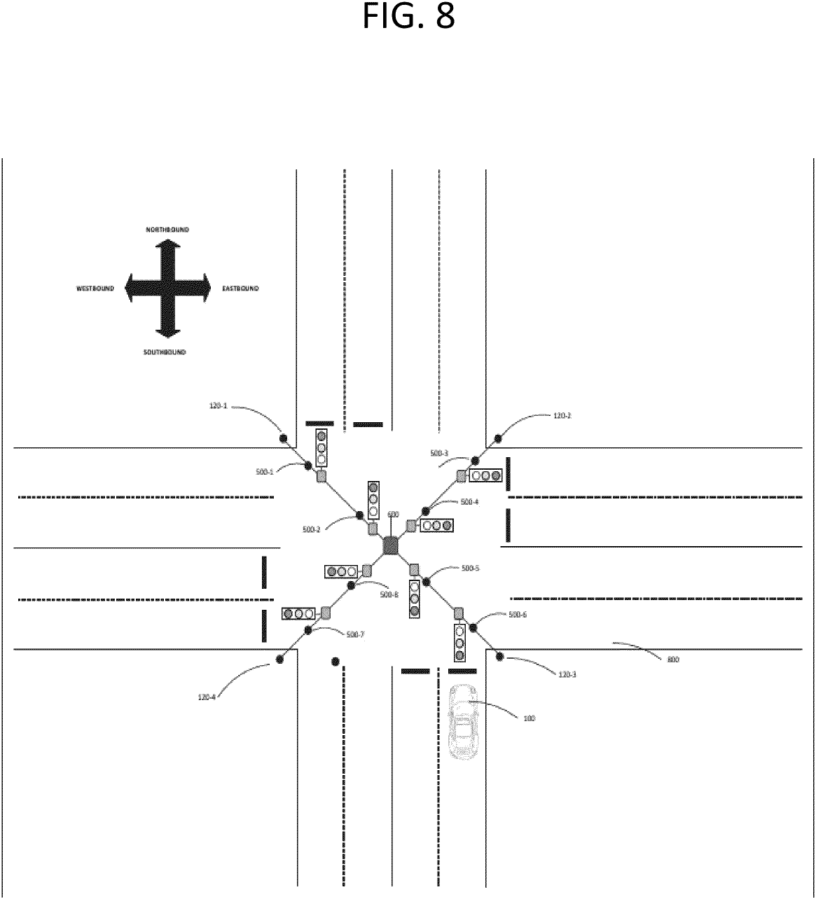

FIG. 8 shows a two-way traffic intersection equipped with TIMS and illustrates the logic for the traffic volume computation. In another example embodiment, the system described in FIG. 1 may be used to provide traffic volume counts for the roads nearby a traffic intersection in real-time and make predictions about the future traffic signal light color. The predicted traffic signal light color may then be published to different subscribers along with the corresponding traffic volume counts. One such embodiment is shown in FIG. 8 which includes a four-way traffic intersection 800 having four signal light posts 120-1, 1202, 120-3, and 120-4. Each of the signal light posts 120-1, 120-2, 120-3, and 120-4 includes or hosts a pair of traffic volume counter devices T-VCD 500-1 and 500-2, 500-3 and 500-4, 500-5 and 500-6, 500-7 and 500-8 respectively. The T-VCD 500-1, 500-2, 500-3, 500-4, 5005, 500-6, 500-7 and 500-8 detect vehicles passing through corresponding lanes of the traffic intersection 800 and wirelessly communicate this information to the device communication controller DCC 600, which processes this information to calculate traffic volume counts for each of the northbound, southbound, eastbound and westbound traffic. In this example embodiment, the wireless communication takes place in the form of a star network using 900 MHz ISM band radios, other communication bands, and network topologies may also be used.

The DCC 600 maintains separate counters for each of northbound, southbound, eastbound, and westbound traffic. The DCC 600 increments the traffic counter for northbound traffic whenever a straight moving northbound vehicle is detected and reported by both of the T-VCD 500-6 and 500-3, or by the T-VCD 500-5 and 500-4. In addition, the traffic counter for northbound traffic is incremented if a westbound vehicle takes a right turn and is detected and reported by the T-VCD 500-3 but no detection reported by the T-VCD 500-1. The traffic counter for northbound traffic is also incremented in case of an eastbound vehicle turning taking left and being detected and reported by both of the traffic volume counter devices T-CVD 500-7 and 500-4, or by the T-CVD 500-8 and 500-4 respectively. The DCC 600 increments the traffic counter for southbound traffic whenever a straight moving southbound vehicle is detected and reported by both of the T-VCD 500-1 and 500-7, or by the T-CVD 500-2 and 500-8. In addition, the traffic counter for southbound traffic is incremented if an eastbound vehicle takes a right turn and is detected and reported by the T-VCD 500-7 but no detection reported by the T-VCD 500-6. The traffic counter for southbound traffic is also incremented in case of a westbound vehicle turning taking left and being detected and reported by both of the traffic volume counter devices T-CVD 500-3 and 500-8, or by the T-CVD 500-4 and 500-8 respectively. The DCC 600 increments the traffic counter for eastbound traffic whenever a straight moving eastbound vehicle is detected and reported by both of the T-VCD 500-7 and 500-6, or by the T-CVD 500-8 and 500-5. In addition, the traffic counter for eastbound traffic is incremented if a northbound vehicle takes a right turn and is detected and reported by the T-VCD 500-6 but no detection is reported by the T-VCD 500-3. The traffic counter for eastbound traffic is also incremented in case of a southbound vehicle turning taking left and being detected and reported by both of the traffic volume counter devices T-CVD 500-1 and 500-5, or by the T-CVD 500-2 and 500-5 respectively. The DCC 600 increments the traffic counter for westbound traffic whenever a straight moving westbound vehicle is detected and reported by both of the T-VCD 500-3 and 500-1, or by the T-CVD 500-4 and 500-2. In addition, the traffic counter for westbound traffic is incremented if a southbound vehicle takes a right turn and is detected and reported by the T-VCD 500-1 but no detection is reported by the T-VCD 500-7. The traffic counter for westbound traffic is also incremented in case of a northbound vehicle turning taking left and being detected and reported by both of the traffic volume counter devices T-CVD 500-6 and 500-2, or by the T-CVD 500-5 and 500-2 respectively.

A technical effect of the systems and methods described herein is achieved by performing at least one of the operations described herein. It will be appreciated that embodiments of the disclosure described herein may be comprised of one or more conventional processors and unique stored program instructions that control the one or more processors to implement, in conjunction with certain non-processor circuits, some, most, or all of the functions of the traffic and intersection monitoring system described herein. As used herein, the term processor refers to central processing units, microprocessors, microcontrollers, reduced instruction set circuits (RISC), application specific integrated circuits (ASIC), logic circuits, and any other circuit or processor capable of executing the functions described herein. The non-processor circuits may include, but are not limited to, a radio receiver, a radio transmitter, signal drivers, clock circuits, power source circuits, and user input devices. As such, these functions may be interpreted as steps of a method of monitoring traffic and/or an intersection with another computing device. Various data disclosed within may be stored in any format on any storage device in or in communication with the computing devices described herein.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

In this document, relative relational terms such as first and second, top and bottom, and the like may be used solely to distinguish one entity or action from another entity or action without necessarily requiring or implying any actual such relationship or order between such entities or actions. The device components, system elements, and method steps described herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The terms “comprises,” “comprising,” or any other variation thereof, are intended to cover a non-exclusive inclusion, such that a process, method, article, or device that comprises a list of elements does not include only those elements but may include other elements not expressly listed or inherent to such process, method, article, or device. An element proceeded by “comprises” does not, without more constraints, preclude the existence of additional identical elements in the process, method, article, or device that comprises the element.

The systems and processes are not limited to the specific embodiments described herein. In addition, components of each system and each process can be practiced independent and separate from other components and processes described herein. Each component and process also can be used in combination with other assembly packages and processes. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Having described aspects of the disclosure in detail, it will be apparent that modifications and variations are possible without departing from the scope of aspects of the disclosure. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A traffic intersection monitoring system, the system comprising of:
a plurality of traffic signal light monitors configured to monitor orientation, viewability, luminous intensity, and color light phase of signal lights installed at a traffic intersection and to generate a first signal indicative thereof;
a plurality of traffic volume counter devices configured to determine a type, direction, and number of vehicles crossing the traffic intersection and to generate a second signal indicative thereof;
a device communication controller installed at the traffic intersection and configured to receive the first signal from the plurality of traffic signal light monitors and the second signal from the plurality of traffic volume counter devices, the device communication controller configured to transmit a third signal to other device communication controllers installed at neighboring traffic intersections and a fourth signal to applicable subscribers of the traffic intersection monitoring system; and
a communication network connecting the traffic signal light monitors, the traffic volume counter devices, and the device communication controllers.

2. The system as set forth in claim 1, wherein the communication network is configured to utilize multiple sources of communication such as wired and wireless communication to deliver the first signal and the second signal to the device communication controllers.

3. The system as set forth in claim 2, wherein the sources of wireless communication comprise at least one of a Bluetooth classic module, Bluetooth low energy module, XBEE module, ZigBee module, Wi-Fi module or 5G or any other generations of the cellular network.

4. The system as set forth in claim 1, wherein the traffic signal light monitor is configured to attach to a sun visor of the traffic signal light and to monitor at least one traffic signal light.

5. The system as set forth in claim 1, wherein each of the traffic signal light monitors comprises an orientation sensor, a vision sensor, and a light sensor to sense the orientation, viewability, luminous intensity, and color light phase of the signal light.

6. The system as set forth in claim 5, wherein the orientation sensor comprises at least one inertial measurement unit (IMU), the vision sensor comprises at least one camera, and the light sensor comprises at least one red green blue (RGB) light sensor.

7. The system as set forth in claim 1, wherein each of the traffic volume counter devices are configured to monitor at least one traffic lane, wherein the traffic lane monitoring comprises a determination of type, direction, and number of vehicles crossing the at least one traffic lane.

8. The system as set forth in claim 1, wherein each of the traffic volume counter devices are configured to be attached to a signal light pole such that a corresponding traffic lane is in the view of the respective traffic volume counter device.

9. The system as set forth in claim 1, wherein each traffic volume counter device comprises at least one camera module or at least one range sensor module or a combination thereof to determine the type, direction, and number of vehicles crossing the traffic intersection.

10. The system as set forth in claim 9, wherein the range sensor module comprises a LiDAR or a RADAR or a combination thereof to determine a vehicle distance from the range sensor, the vehicle size, the number of vehicles crossing the traffic intersection, and the direction of a vehicle.

11. The system as set forth in claim 1, wherein the device communication controller is configured to receive signals from the traffic signal light monitors, from the traffic volume counter devices, and from the other device communication controllers located at the neighboring traffic intersections.

12. The system as set forth in claim 1, wherein the device communication controller is configured to transmit the third signal to the other device communication controllers located at the neighboring traffic intersections and transmit the fourth signal to the applicable subscribers directly to an existing vehicle, to every communication interface or and to the available cellular networks and any other compatible communication interface, or a combination thereof.

13. The system as set forth in claim 1, wherein the device communication controller can transmit the fourth signal to a cloud-based application server for the applicable subscribers.

14. The system as set forth in claim 1, wherein the device communication controller is installed at a fixed location with known location coordinates and comprises at least one GNSS module, the device communication controller being configured to compare the location coordinates reported by the GNSS with its known location coordinates and publish the error in the GNSS location coordinates for the applicable subscribers.

15. A method for traffic intersection monitoring system, the method comprising:
detecting traffic signal light integrity (orientation, viewability, luminous intensity) and color light phase of a traffic intersection;
detecting the type, direction, and number of vehicles crossing the traffic intersection;
propagating the detection data over a wired or wireless network of traffic signal light monitors, traffic volume counter devices, and device communication controllers; and
executing a computer program on the device communication controllers to determine an error in the GNSS location coordinates, the number of vehicles heading toward neighboring traffic intersections, predicting the number of vehicles expected to arrive at the traffic intersection, current traffic signal light phase, time of the future traffic signal light phase change and reporting this information to applicable subscribers of the traffic intersection monitoring system.

16. The method of claim 15, wherein the detecting of the traffic signal light integrity and color light phase comprises processing an output of a plurality of diverse sensors on the traffic signal light monitors.

17. The method of claim 15, wherein the detecting of the type, direction, and the number of vehicles comprises processing an output of a plurality of diverse sensors on the traffic volume counter devices.

18. The method of claim 15, wherein the error in the GNSS location coordinates, the number of vehicles heading toward neighboring traffic intersections, the number of vehicles expected to arrive at the traffic intersection, the current traffic signal light phase, and the time of the future traffic signal light phase change reporting to the applicable subscribers is transmitted to the available cellular networks, or to a vehicle, or to every communication interface or a combination thereof.

19. The method of claim 15, wherein the computer program is an artificial intelligence-based program comprising convolutional neural networks, temporal convolutional networks, recurrent neural networks, and long short-term memory networks.
